(19) United States
(12) Patent Application Publication
(10) Pub. No.: US 2020/0093141 A1
(43) Pub. Date: Mar. 26, 2020

(54) KNIFE HAVING SCALES

(71) Applicants: Ayame NARA, Saitama Pref. (JP); Yuki FUKUDA, Kanagawa Pref. (JP); Ayumi NISHIMINE, Tokyo (JP); Kana NAGASAWA, Chiba Pref. (JP); Keigo NAOI, Chiba Pref. (JP); Kazuma FUJISAWA, Tokyo (JP); Miho ISHIDA, Tokyo (JP); Yuka YAMANAKA, Chiba Pref. (JP); Kai KOMIYA, Tokyo (JP)

(72) Inventors: Ayame NARA, Saitama Pref. (JP); Yuki FUKUDA, Kanagawa Pref. (JP); Ayumi NISHIMINE, Tokyo (JP); Kana NAGASAWA, Chiba Pref. (JP); Keigo NAOI, Chiba Pref. (JP); Kazuma FUJISAWA, Tokyo (JP); Miho ISHIDA, Tokyo (JP); Yuka YAMANAKA, Chiba Pref. (JP); Kai KOMIYA, Tokyo (JP)

(21) Appl. No.: 16/699,142

(22) Filed: Nov. 29, 2019

(51) Int. Cl. A21C 15/04; B26B 29/06

(52) U.S. Cl. CPC A21C 15/04; B26B 29/063

(57) ABSTRACT

A knife having scales includes a U-shaped handle having a first shaft and a second shaft, a first fixed knife, which is coupled with the handle, a second movable knife, which is able to connect to and move along the first shaft in order to divide an object by a desired angle, and a protractor, which is possible to be put on the first shaft, and is used as a guide for dividing the object into desired numbers, each of which is equal amount, wherein scales are shown on the protractor, and wherein the scales are grouped in accordance with the number that the object is divided.

### BACKGROUND OF INVENTION

### 1. Field of the Invention

This invention has been made by the members of MIMURA Seminar, College of Law, Nihon Univ, as a team. The present invention relates to a knife for dividing cylindrical food, such as a whole case, into desired and equal sections.

### 2. Description of the Related Art

Nine (9) inventor are involved in this invention. We bought a round whole cake to celebrate one of the inventors' birthday. We tried to divide it nine equal parts to eat it by the inventors. If the number of the inventors is even, it's easy to divide it equally in the way for cutting it in half, and then for re-cutting that piece in half. However, that method does not work for odd numbers. Thus, it is not easy for dividing a round cake equally in odd number by using the knife only. For this reason, a cake cutter having a protractor was proposed. According to such a-cake cutter having a protractor, it is necessary to find the center of the round cake, and to measure its radius, initially. But it is not easy to find it. Thus, it should be relayed on rough judgement to fix the center of the round cake, according to the cake cutter in the related arts. Next, the center of the round cake is overlaid on the center of the protractor, and then the round case is cut along a line showing the zero of the protractor. After that, the round case is cut every forty (40) degree, namely the cake is divided into nine pieces, each having the same quantity. According to the cake cutter in the related arts, it is difficult to see a scale of the protractor unless the cake cutter is placed close to cake. On the other hand, it is not easy to use the knife under this situation because of the interference by the protractor.

### SUMMARY OF THE INVENTION

An objective of the present invention is to resolve the above described problem and provide a knife having scales including a U-shaped handle having a first shaft and a second shaft, a first fixed knife, which is coupled with the handle, a second movable knife, which is able to connect to and move along the first shaft in order to divide an object by a desired angle, and a protractor, which is possible to be put on the first shaft, and is used as a guide for dividing the object into desired numbers, each of which is equal amount, wherein scales are shown on the protractor, and wherein the scales are grouped in accordance with the number that the object is divided.

### BRIEF DESCRIPTION OF THE DRAWINGS

The invention will be more particularly described with reference to the accompanying drawings, in which:

FIG. 1 is a front view of a knife having scales of the invention;

FIG. 2a is an enlarged front view of a fixed knife composed of the knife shown in FIG. 1;

FIG. 2b is an upper view of the fixed knife shown in FIG. 2a;

FIG. 3 is a front view of an enlarged moveable knife composed of the knife shown in FIG. 1;

FIG. 4 is an enlarged front view of a handle composed of the knife shown in FIG. 1;

FIG. 5a is a front view of the knife shown in FIG. 1 when the movable knife is lifted;

FIG. 5b a perspective view of the knife shown in FIG. 1 when the movable knife revolves a certain degree; and

FIG. 6 is an upper view of a protractor of the knife shown in FIG. 1.

### DETAILED DESCRIPTION OF THE PREFERRED EMBODIMENTS

A preferred embodiment of the invention as to a knife having scales is explained together with drawings as follows. In each drawing, the same reference numbers designate the same or similar components through all embodiments.

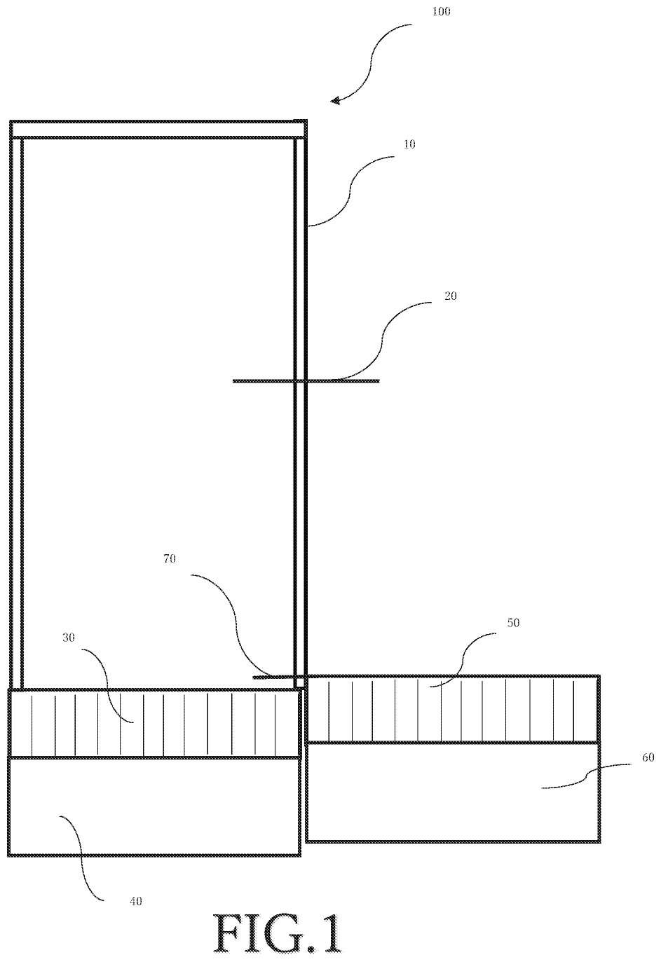

As shown in FIG. 1, the knife having scales 100 of a present invention includes handle 10, a fixed knife 40 having a first scale region 30, a movable knife 60 having a second scale region 50, a protractor 20 fixed to the handle 10, and a ring 70.

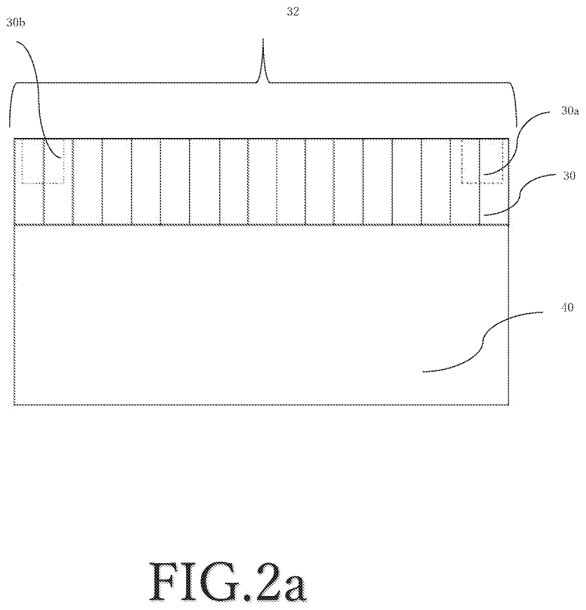

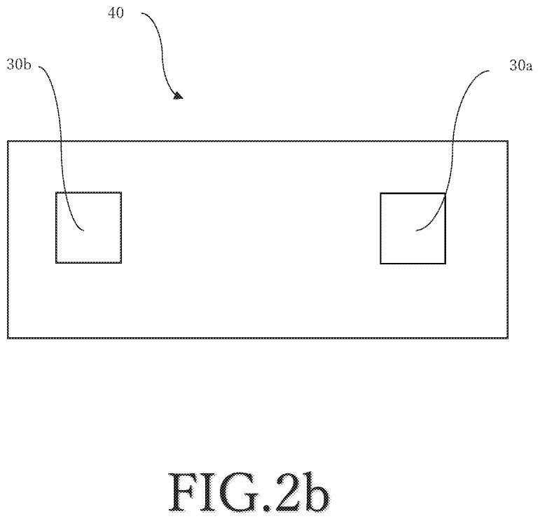

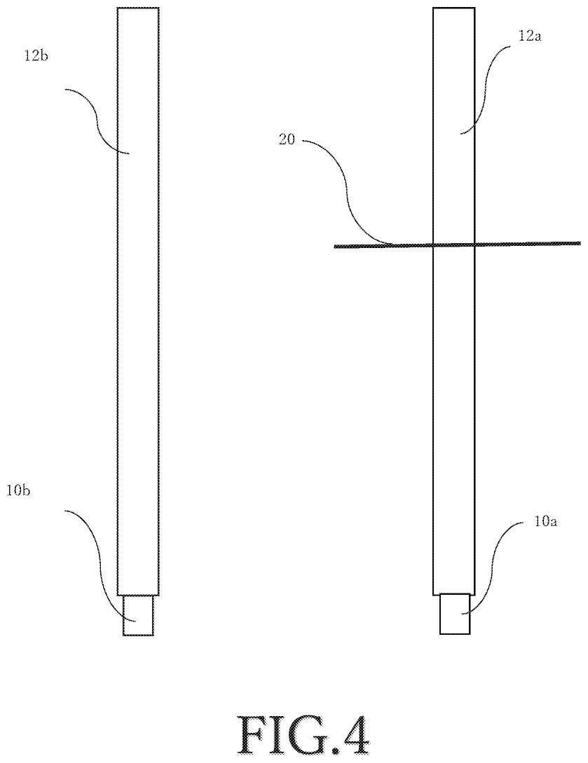

As shown in FIG. 2A and FIG. 2B, the fixed knife 40 has a first and a second dents 30a, 30b, which are formed in the upper part of the first scale region 30. As shown in FIG. 4, the handle 10 is formed of a first shaft a and a second shaft 12b, each of which has a first convex 10a and a second convex 10b at its one end, respectively. At their other ends, the first and second shaft 12a, 12b are connected. The handle 10 is U-shaped. The first and the second convex 10a, 10b are engaged with the first and the second dents 30a, 30b, respectively.

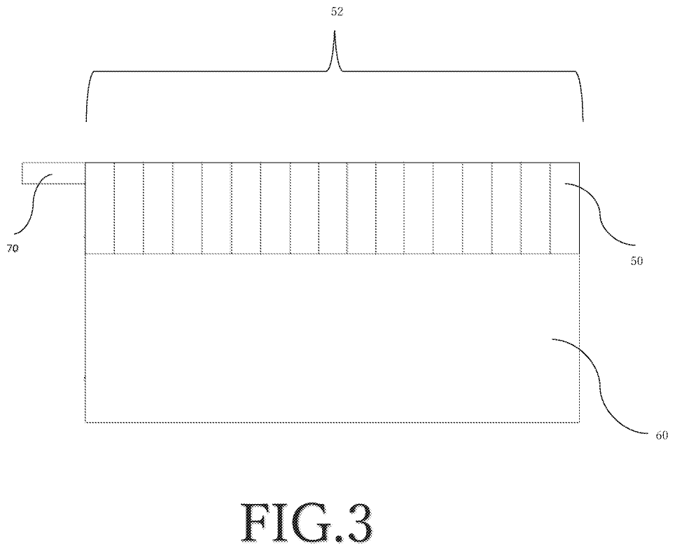

As shown in FIG. 3, the movable knife 60 having the second scale region 50 includes the ring 70 at its end. The movable knife 60 is engaged to the first shaft 12a of handle 10 with the ring 70. Thus, the internal diameter of the ring 70 is set to be nearly equal to or slightly larger than the external diameter of the first shaft 12a. The scale 52 is lined with one (1) inch in the second scale region. As well, as shown in FIG. 2A, the scale 32 is lined with one (1) inch in the first scale region 30 of the fixed knife 40. As described later, the scale formed in the first scale region 30 is rolled in finding the center of the objects being cut.

The protractor 20, which is formed of transparence or semitransparent material, such as plastic, includes a notch so that it can be put plug on the first shaft 12a of the handle 10. The reason why the protractor 20 is formed independent from the handle as a part is that the protractor 20 can be put on the first shaft at the desired location. In other words, if the thick objects, such as a hole cake is cut, the protractor 20 can be put on the first shaft 12a at the relatively high location, while if the thin object, such as it can be put on the first shaft 12a at the relatively low location. To do so, material having high frictional coefficient may be used at the surface of the protractor 20 in the notch.

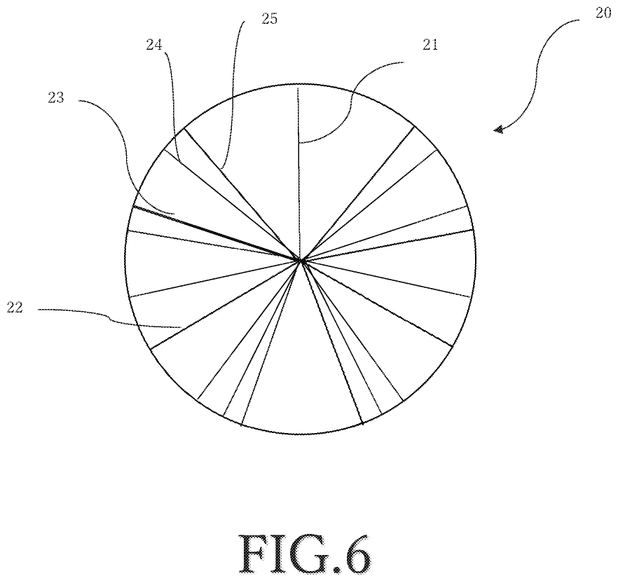

Further, as shown in FIG. 6, scales 22, 23, 24, 25 are printed on the protractor 20. Each group of the scales is colored differently. For example, when the object is cut into three, the lines belonging to the scale 22, each of which is lined from a base line 21 with 120 degrees, are used. As well, when the object is cut into five, the lines belonging to the scale 23, each of which is lined from a base line 21 with 72 degrees, are used. As further well, when the object is cut into seven or nine, the lines belonging to the scale 24 or scale 25, each of which is lined from a base line 21 with 51.4 degrees or 40 degree, respectively, are used. As mentioned above, each group of the scale is colored differently, for example, the scale 22 is colored in red, the scale 23 is colored in blue, the scale 24 is colored in green and the scale 25 is colored in yellow, it is easy for the user to find the scale to be selected.

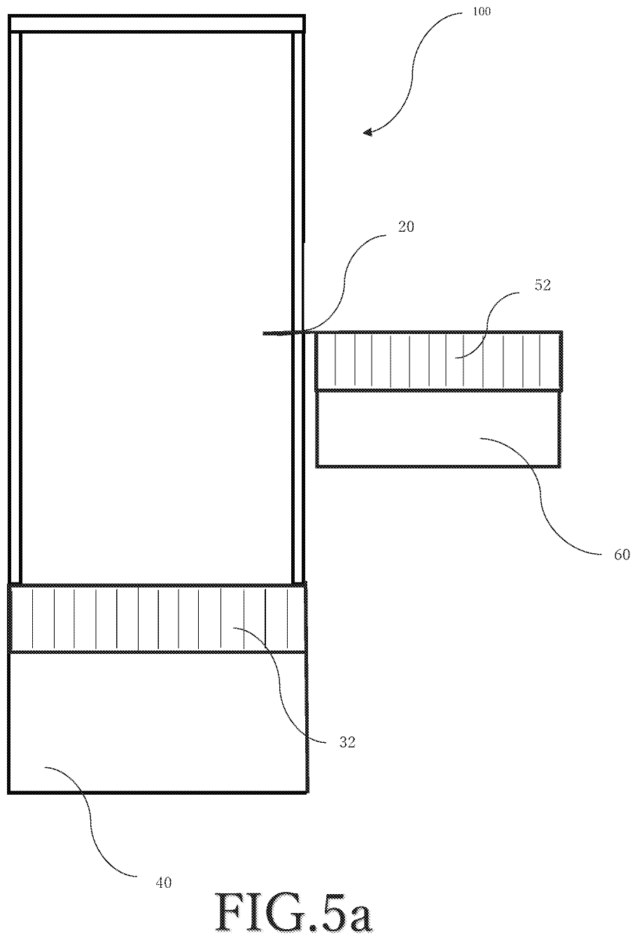

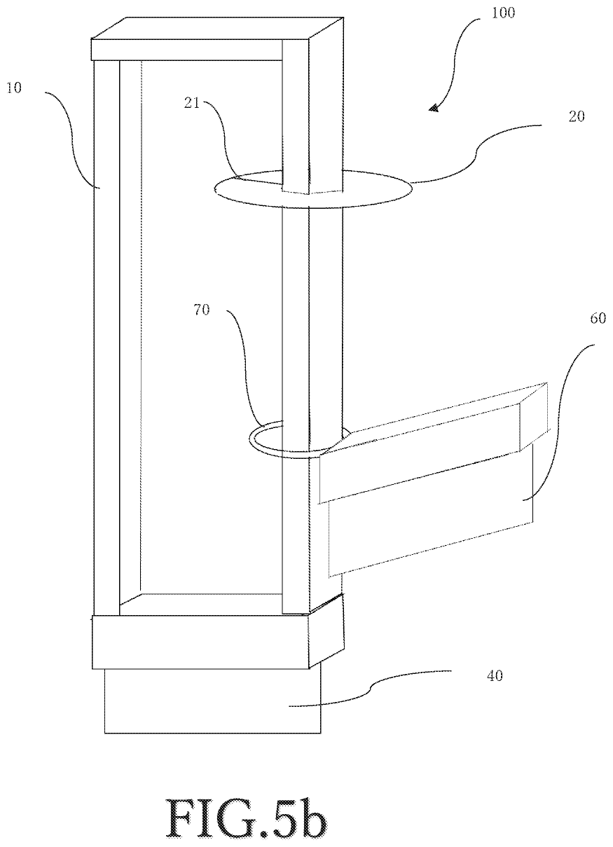

The knife having the scale 100 is used as follows when a round cake is divided into three equal parts. As shown in FIG. 5a, initially, the movable knife 60 is moved on the first shaft 12a toward the protractor 20. Next the fixed knife 40 is inserted into the round cake. At this time, if the diameter of the cake is 8 inches, the fourth line of the first scale 32 counted from the edge and the fourth line of the second scale 52 counted from the edge are set to be located at the peripheral of the round cake to find the center of the round cake.

After that, as shown in FIG. 5a, one third piece of the cake is separated by rotating the movable knife 60 along the scale 22 on the protractor 20, and by moving it down into the case. Then, the movable knife 60 is moved above and rotated along another scale 22 on the protractor 20. Then, the movable knife 60 is moved down into the cake to divide another one third pieces of the case. The position of the movable knife 60 is recognized through protractor 20 by looking down from above because the protractor 20 is formed of the transparent material as described.

While the invention has been described with reference to illustrative embodiments, this description is not intended to be construed in a limiting sense. For example, the ring 70 may be used as a protractor if it has scales. Thus, shapes, size and physical relationship of each component are roughly illustrated so the scope of the invention should not be construed to be limited to them. Further, to clarify the components of the invention, hatching is partially omitted in the cross-sectional views.

Various other modifications of the illustrated embodiment will be apparent to those skilled in the art on reference to this description. Therefore, the appended claims are intended to cover any such modifications or embodiments as fall within the true scope of the invention.

We claim:

1. A knife having scales, comprising:
a U-shaped handle having a first shaft and a second shaft;
a first fixed knife, which is coupled with the handle;
a second movable knife, which is able to connect to and move along the first shaft in order to divide an object by a desired angle; and
a protractor, which is possible to be put on the first shaft, and is used as a guide for dividing the object into desired numbers, each of which is equal amount, wherein scales are shown on the protractor, and wherein the scales are grouped in accordance with the number that the object is divided.

2. A knife as claimed in claim 1, wherein the first fixed knife includes a first scale region where a scale is formed therein, and wherein the second movable knife includes a second scale region where another scale is formed therein.

3. A knife as claimed in claim 2, wherein the second movable knife is rotatable around the first shaft.

4. A knife as claimed in claim 1, wherein the protractor includes a notch whereby the protractor is fixed on the first shaft by inserting the first shaft into the notch.

5. A knife as claimed in claim 1, wherein the scale formed on the protractor include a base line, a first group having lines which are spaced by 120 degrees and a second group which are spaced by 72 degrees.

6. A knife having graduation as claimed in claim 5, wherein the lines in the first group is colored in a particular color and the lines in the second group is colored in another color, which is different from the color being used for the line in the first group.

7. A knife as claimed in claim 1, wherein the protractor is transparent.

8. A knife as claimed in claim 1, wherein the protractor is semitransparent.

9. A knife as claimed in claim 7, wherein the protractor is formed of plastics.

10. A knife as claimed in claim 8, wherein the protractor is formed of plastics.
